(19) United States
(12) Patent Application Publication
(10) Pub. No.: US 2010/0067693 A1
(43) Pub. Date: Mar. 18, 2010

(54) SYSTEM AND METHOD OF ENABLING CONTENT OUTPUT ON A DIGITAL DEVICE

(75) Inventors: Jeffrey Courington, Chester, VA (US); Jeffrey Segal, Midlothian, VA (US); Robert Schumann, Oakton, CA (US)

Correspondence Address: Dolby Laboratories Inc., 100 Potrero Avenue, San Francisco, CA, 94103-4938, US

(73) Assignee: DOLBY LABORATORIES LICENSING CORPORATION, San Francisco, CA (US)

(21) Appl. No.: 12/555,467

(22) Filed: Sep. 8, 2009

Related U.S. Application Data
(60) Provisional application No. 61/097,796, filed on Sep. 17, 2008.

(51) Int. Cl. H04N 7/167; H04L 9/00; G06F 3/048

(52) U.S. Cl. 380/210; 380/42; 715/716

(57) ABSTRACT

In one embodiment the present invention includes a system and method of distributing content. Authorization information is encoded with the content. When received and decoded, if a particular device output is authorized by the authorization information, then the content is output. By encoding the authorization information along with the content, unauthorized display of the content is reduced.

### CROSS REFERENCE TO RELATED APPLICATIONS

This application claims priority to U.S. Provisional Patent Application No. 61/097,796, filed 17 Sep. 2008, hereby incorporated by reference in its entirety.

### BACKGROUND

The present invention relates to enabling content output, and in particular, to generating and embedding access codes into content data for controlling the output of the content.

Unless otherwise indicated herein, the approaches described in this section are not prior art to the claims in this application and are not admitted to be prior art by inclusion in this section.

Content (such as television programs, music and movies) is often distributed in a broadcast manner. The content may be encrypted (also referred to as scrambled), so that only authorized devices may display the content. However, once the decryption (also referred to as descrambling) has occurred, the content is no longer protected and may be further distributed in an unauthorized manner. Furthermore, there are several devices on the market (such as VCR and DVD recorders) that allow analog copies to be made easily. The analog port on a set top box may allow content to escape to a VCR via an analog hole.

### SUMMARY

Embodiments of the present invention are directed to improving security when displaying content. In one embodiment the present invention includes a method of distributing content. The method includes associating an authorized display mode with the content. The method further includes generating a transport stream that includes the content and the authorized display mode. The method further includes encoding the transport stream. The method further includes transmitting, by a first device, the transport stream having been encoded. The method further includes receiving, by a second device, a device display mode. The method further includes decoding the transport stream to generate the content and the authorized display mode. The method further includes comparing the device display mode and the authorized display mode. The method further includes outputting the content according to a result of the comparing. In this manner, the authorized display mode is protected via encoding as is the content.

According to an embodiment of the present invention, the above method is implemented by a content distribution system.

According to an embodiment of the present invention, a receiver device includes a decoder, a conditional access system, and an output. The decoder receives an encoded transport stream. The encoded transport stream includes the content and an authorized display mode. The decoder decodes the transport stream to generate the content and the authorized display mode. The conditional access system is coupled to the decoder and receives a device display mode. The conditional access system compares the device display mode and the authorized display mode, and outputs a control signal. The output is coupled to the decoder and to the conditional access system, and outputs the content according to the control signal.

The following detailed description and accompanying drawings provide a better understanding of the nature and advantages of the present invention.

### BRIEF DESCRIPTION OF THE DRAWINGS

FIG. 1 is a block diagram of a content distribution system according to an embodiment of the present invention.

FIG. 2 is block diagram of the distribution device (see FIG. 1) according to an embodiment of the present invention.

FIG. 3 illustrates an example of a transport stream according to an embodiment of the present invention.

FIG. 4 is a block diagram showing details of the receiver device (see FIG. 1) according to an embodiment of the present invention.

FIG. 5 is a flow diagram of a method of distributing content according to an embodiment of the present invention.

### DETAILED DESCRIPTION

Described herein are techniques for enabling content output. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

Various method and processes are described below. That they are described in a certain order is mainly for ease of presentation. It is to be understood that particular steps may be performed in other orders or in parallel as desired according to various implementations. When a particular step must precede or follow another, such will be pointed out specifically when not evident from the context.

In the following description, the terms “encoding”, “encoder”, “encryption”, “encrypting”, “scrambling”, and related forms thereof, are used. It is intended that these terms are interchangeable. Similarly the terms “decoding”, “decoder”, “decryption”, “decrypting”, “descrambling”, and related forms thereof, are intended to be interchangeable.

In the following description, the term “content” is used. In general, content refers to digital information such as picture data, video data (including video on demand), and audio data. In general, content may be distributed via physical copies (such as compact disks, video disks and hard disks) and via transmission (such as radio signals, satellite signals, and computer network data). In general, content is subject to copyright (e.g., an original work of authorship fixed in a tangible form of expression).

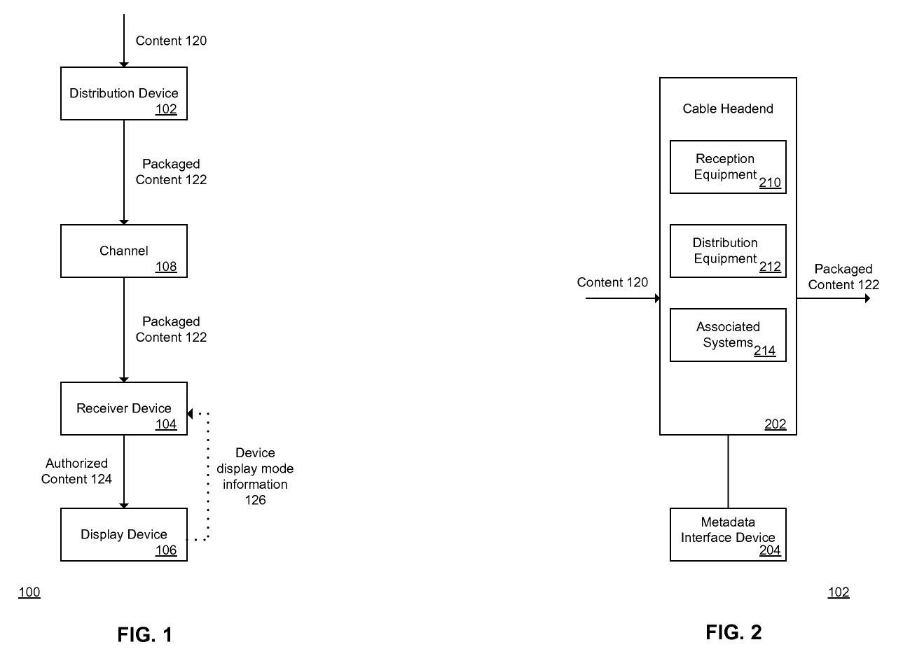

FIG. 1 is a block diagram of a content distribution system 100 according to an embodiment of the present invention. The content distribution system 100 includes a distribution device 102, a receiver device 104, and a display device 106. A communications channel 108 connects the distribution device 102 and the receiver device 104.

The distribution device 102 receives content 120 and generates packaged content 122. The content 120 is the original content, for example, a high definition video. The packaged content 122 includes the content 120 and information identifying the authorized display modes for the content 120. The distribution device 102 encodes the packaged content 122 as part of the packaging process. The specifics of the packaging process performed by the distribution device 102 are provided in more detail below.

The communications channel 108 provides the packaged content 122 from the distribution device 102 to the receiver device 104. The communications channel 108 may be the airwaves (for television broadcasts or satellite broadcasts), a cable network (for cable television signals), the internet (for internet video), etc., depending upon the specific technology implemented in the distribution device 102 and the receiver device 104.

The receiver device 104 receives the packaged content 122 and generates authorized content 124, if so indicated by device display mode information 126. The device display mode information 126 indicates the display attributes of the display device 106 to the receiver device 104. The receiver device 104 decodes the packaged content and generates the authorized content 124 when the device display mode information 126 indicates a match with the authorized display mode information.

Alternatively, the matching of the device display mode information 126 and the authorized display mode information may be used as part of the decoding process. That is, if the display device 106 includes a display mode corresponding to the authorized display modes, the receiver device 104 successfully decodes the packaged content 122. If the display device 106 does not include a display mode corresponding to the authorized display modes, then the receiver device 104 fails to successfully decode the packaged content 122.

The display device 106 displays the authorized content 124 when the receiver device 104 successfully decodes the packaged content 122. When the receiver device 104 fails to successfully decodes the packaged content 122, for example when the display device 106 does not include an authorized display mode, the display device 106 may display an error message. The display device 106 may be a television, a high-definition television, a mobile device such as a cellular telephone, a hand held video device such as an iPod™, etc. The display device may include one or more display modes, including SCART, composite component, RGB, PC, HDMI, DVI, HDCP/HDMI, HDCP/DVI, etc.

For example, consider the following configuration. The content 120 is a high definition movie that the content owner would like to distribute to devices authorized according to the HDMI/HDCP standard (high definition multimedia interface/high-bandwidth digital content protection). The distribution device 102 is a cable headend. The cable headend adds the HDMI/HDCP information as the device display mode information 126 to the content 120, performs encryption, and outputs the packaged content 122. The receiver device 104 is a set-top box, and the display device 106 is a television; both are connected via HDMI using HDCP. The key contained in the ECM/EMM packets is used by the set top box to decrypt the encoded video. The video is then decoded and encrypted to be sent on the HDMI/HDCP link. The HDMI receiver in the television then decrypts the video and displays it.

FIG. 2 is block diagram of the distribution device 102 (see FIG. 1) according to an embodiment of the present invention. The distribution device 102 includes a cable headend 202 and a metadata interface device 204.

The cable headend 202 includes the equipment involved in receiving and distributing content, as well as associated systems 214 (power supply, control, etc.), which for conciseness are not detailed. Reception equipment 210 may include satellite downlink equipment, broadcast reception antennas, microwave antennas, communications network equipment, internet connection equipment, fiber optic equipment, and associated demodulation or demultiplexing equipment. Distribution equipment 212 may include security authority systems, router devices, modulator devices and multiplexing devices.

The metadata interface device 204 may be part of the control system for the cable headend 202. The metadata interface device 204 may be a computer that executes a control program for managing metadata related to the content, as more fully detailed below. The metadata interface device 204 may include input components, output components, communication components, processing components, and storage components, as well as associated components (power supply, device interfaces, buses, etc.), which for conciseness are not detailed. The input components may include a keyboard, mouse, trackball, and touch screen. The output components may include a display screen and speaker. The communication components may include a modem, a network interface, a universal serial bus interface, and a wireless interface. The processing components may include one or more microprocessors and device controllers. The storage components may include memory devices (ROM, RAM, DRAM, SRAM, Flash memory, etc.), fixed storage devices (hard disk drives, etc.), and removable storage devices (DVD drives, CD-ROM drives, etc.).

The metadata interface device 204 implements features that allow the authorized display mode information to be associated with a particular piece of content. According to an embodiment, the content is a digital data file, and the authorized display mode information is metadata associated with the digital data file. The metadata may be formatted in a variety of ways, including the XML (extensible markup language) format.

According to an embodiment, the metadata may be formatted according to “ADI 2.0 Specification Asset Structure”, MD-SP-ADI2.0-AS-103-070105, by Cable Television Laboratories, Inc., Louisville, Colo. An example of metadata formatted according to the ADI 2.0 specification is as follows:

<adi:AcceptContentAsset type=“video” product=“VOD” ... >
<vod:Video ... >
...
<allowedOutputConnection>HDMI/HDCP</allowedOutputConnection>
...
</vod:Video>
</adi:AcceptContentAsset>

The metadata above allows output to a device supporting the HDMI/HDCP display protocol. HDMI is the physical link connection and HDCP is the encryption protocol.

The content and the metadata then travel together until they reach the security authority system. The security authority system may convert the metadata into a binary format or otherwise as appropriate for transfer according to the security system's content control format, such as an ECM (entitlement control message) security structure. As one example, sixteen bits of binary information may be used to represent the following nine values:

SCART composite component RGB VGA HDMI DVI HDCP/HDMI HDCP/DVI which encodes as follows into sixteen bits (with the seven rightmost bits unused):

0000000110000000

or in hexadecimal:

0x0180

Thus, the two “1”s correspond to the HDCP/HDMI and HDCP/DVI outputs enabled.

SCART refers to the Syndicat des Constructeurs d'Appareils Radiorécepteurs et Téléviseurs standard audio/visual connector. RGB refers to red, green, and blue color components. VGA refers to a video graphics array connector, which may be used for computer monitors. DVI refers to the digital video interface standard.

According to an embodiment, a different number of bits than 16 may be used to convey more or less information, as desired to represent various available control formats.

The security authority system then packages the allowed output selections into the security structures in the transport stream. The transport stream may be encrypted.

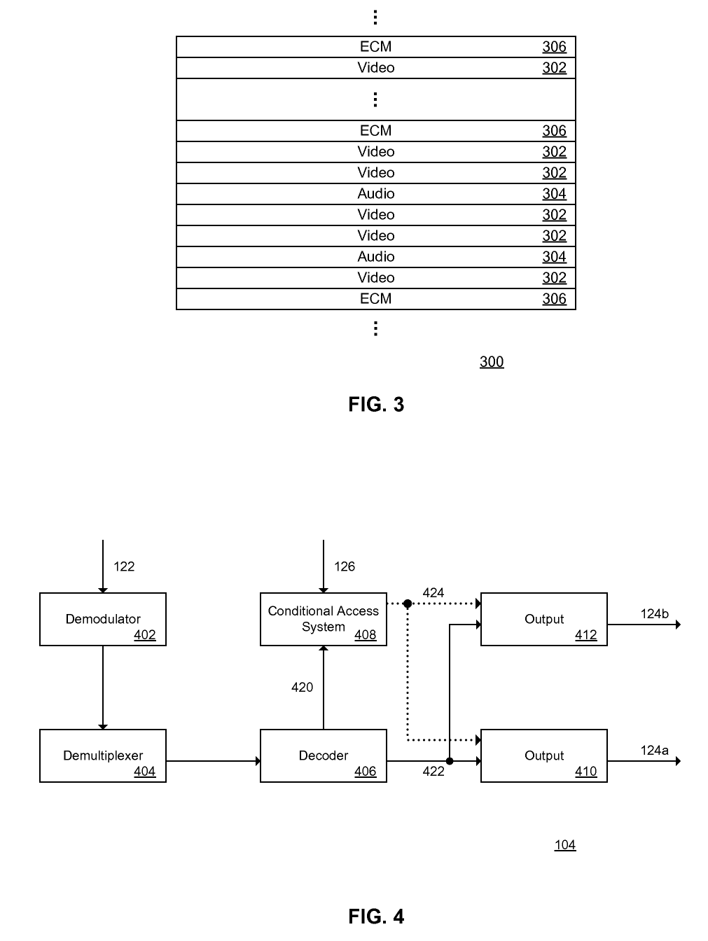

FIG. 3 illustrates an example of a transport stream 300 according to an embodiment of the present invention. The transport stream 300 may be in the MPEG-2 format. The transport stream 300 includes video portions 302, audio portions 304, and ECM/EMM portions 306. (EMM refers to an entitlement management message.) The video portions 302, audio portions 304, and ECM/EMM portions 306 may be multiplexed. Since the output selection information travels in the ECM/EMM portions 306, it is protected by the same security system as the video portions 302. The particular format of the ECM/EMM portions 306 may be proprietary to each security vendor, therefore the position of the output selection data in the ECM/EMM portions 306 may differ according to the security vendor.

Although the embodiment of FIG. 2 is directed toward a cable headend, it is to be understood that other content distribution networks may also be used according to embodiments of the present invention. For example, the distribution device 102 may include a satellite uplink facility, an internet video server, a content delivery network (such as iTunes™, etc.), etc.

FIG. 4 is a block diagram showing details of the receiver device 104 (see FIG. 1) according to an embodiment of the present invention. The receiver device 104 may be a set top box. The receiver device 104 includes a demodulator 402, a demultiplexer 404, a decoder 406, a conditional access system 408, and outputs 410 and 412. The receiver device 104 may also include other components (input interfaces, output interfaces, power system, control system, processor, memory, etc.) that for conciseness are not detailed.

The demodulator 402 receives the packaged content 122 from the communications channel 108 (see FIG. 1) and demodulates the transport stream. The demodulator 402 generates and provides the demodulated transport stream to the demultiplexer 404.

The demultiplexer 404 receives the demodulated transport stream from the demodulator 402 and demultiplexes the transport stream. The demultiplexer 404 generates and provides the demultiplexed transport stream to the decoder 406.

The decoder 406 receives the demultiplexed transport stream from the demultiplexer 404 and decodes the transport stream. Decoding may also be referred to as decrypting or descrambling. The decoder 406 may perform MPEG-2 decoding, H.264 decoding, or another type of decoding. The decoder 406 generates the decoded authorized display mode information 420 to the conditional access system 408, and generates the decoded content 422 to the outputs 410 and 412.

The conditional access system 408 receives the decoded authorized display mode information 420 from the decoder 406, and receives the device display mode information 126 from the display device 106 (see FIG. 1). A comparison between the decoded authorized display mode information 420 and the device display mode information 126 indicates which of the outputs 410 and 412 are enabled for the content (see the above discussion regarding the authorized display mode information). The conditional access system 408 generates control information 424 to the outputs 410 and 412.

The outputs 410 and 412 receive the decoded content 422 and the control information 424. If the control information 424 indicates that the output 410 has been authorized to output the decoded content 422 (as indicated by the authorized display mode information as discussed above), the output 410 generates the corresponding output signal 124a. If the control information 424 indicates that the output 412 has been authorized to output the decoded content 422 (as indicated by the authorized display mode information as discussed above), the output 412 generates the corresponding output signal 124b.

The number and specific configurations of the outputs 410 and 412 may vary according to the overall design constraints of the receiver 104. For example, a particular set top box may have four outputs: an MPEG audio output, an MPEG video output, an RGB output, and an HDCP/HDMI output. A standard set top box may have two outputs: an analog audio output (for example, stereo RCA (Radio Corporation of America) outputs), and an analog video output (for example, composite, component, or SCART). A high definition set top box may have four outputs: an analog audio output, an analog video output, a digital audio output (for example, Sony/Philips Digital Interconnect Format (more commonly known as Sony Philips Digital InterFace) or optical), and a digital video output (for example, HDMI or DVI).

The decoded content 422 may vary depending upon the specific configuration of the outputs 410 and 412. For example, when MPEG-2 decoding is performed, the decoded content 422 may include an audio component and a video component. The audio component may be provided to the output 410 and the video component may be provided to the output 412.

Furthermore, a particular configuration for the output 410 need not receive the control information 424. For example, for MPEG-2 decoding, the audio output may be provided to the output 410 for generating the output 124a without any connection to the conditional access system 408.

Similarly, the particular control information 424 provided to each of the outputs 410 and 412 may vary depending upon the desired configuration of the receiver 104. For example, if the output 410 corresponds to MPEG audio and the output 412 corresponds to MPEG video, the control information 424 may be a single bit of information that indicates either that both outputs are authorized, or that neither output is authorized. Alternatively, the control information 424 may include a first component provided to the output 410 indicating whether the audio output is authorized, and a second component provided to the output 412 indicating whether the video output is authorized; in such a case, there is no need for the output 410 to receive the second component. Further alternatively, both components may be provided to the output 410, and the output 410 only performs audio output when authorized according to the first component.

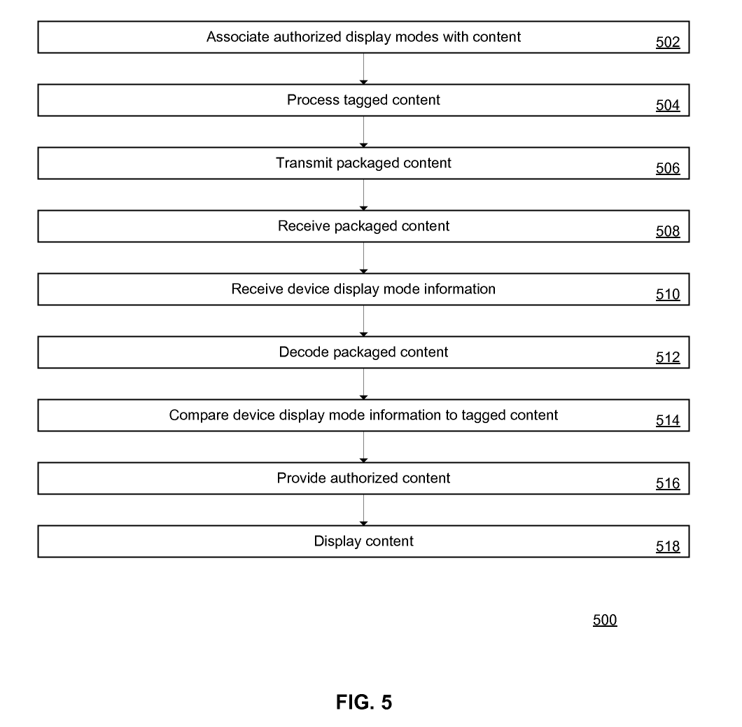

FIG. 5 is a flow diagram of a method of distributing content 500 according to an embodiment of the present invention. The method 500 may be performed by one or more of the components of the content distribution system 100 (see FIG. 1).

In step 502, one or more authorized display modes are associated with a particular piece of content. The authorized display modes may be formatted as metadata or other tags that are associated with a data file representing the content. A device such as the metadata interface device 204 (see FIG. 2) may be used to associate the authorized display modes with the content. The content together with the associated authorized display modes may be referred to as “tagged content”.

In step 504, the tagged content is processed according to the specifics of the distribution system 102 (see FIG. 1). For example, the tagged content may be formatted into video portions, audio portions, and security portions. The processing includes encoding the content and authorized display modes together, so that the same security protects both. The processing may also include modulating, multiplexing, or other modifications as appropriate for the communications channel 108. A device such as the distribution device 102 (see FIG. 2) may be used to process the tagged content. The processed, tagged content may be referred to as “packaged content” (see FIG. 1).

In step 506, the packaged content is transmitted over the communications channel 108 (see FIG. 1). A device such as the distribution device 102 (see FIG. 2) may be used to transmit the packaged content.

In step 508, the packaged content is received. A device such as the receiver device 104 (see FIG. 1) may be used to receive the packaged content. The packaged content may be demodulated, demultiplexed, or otherwise modified as appropriate.

In step 510, device display mode information is received. A device such as the display device 106 may communicate the device display mode information to the receiver device 104 (see FIG. 1) to indicate that the display device 106 has a particular type of input.

In step 512, the packaged content is decoded, resulting in the tagged content. A device such as the receiver device 104 (see FIG. 1) may be used to decode the packaged content. The tagged content may be further processed to separate the authorized display mode information from the content.

In step 514, the device display mode information is compared to the tagged content. A device such as the receiver device 104 (see FIG. 1) may be used to compare the device display mode information 126 to the tagged content. More specifically, the device display mode information is compared to the authorized display mode information. If the device display mode information corresponds to the authorized display mode information, then the display device is authorized to display the content. If the device display mode information does not correspond to the authorized display mode information, then the display device is not authorized to display the content.

In step 516, if the display device has been authorized to display the content (see step 514), the authorized content is provided to the display device. For example, the receiver device 104 generates the authorized content 124 (see FIG. 1) when the receiver device 106 has determined that the display device 106 has been authorized to display the content. If the display device has not been authorized to display the content, an informational error message may be provided to the display device.

In step 518, the authorized content is displayed (if so provided in step 516).

In addition to the steps detailed above, various substeps may be performed by various devices that implement the method, such as the receiver device 104. The details of these substeps may be seen in the corresponding figure and related description (see, for example, FIG. 4 and related description).

Implementation

The invention may be implemented in hardware, executable modules stored on a computer readable medium, or a combination of both (e.g., programmable logic arrays). Unless otherwise specified, the steps included as part of the invention are not inherently related to any particular computer or other apparatus. In particular, various general-purpose machines may be used with programs written in accordance with the teachings herein, or it may be more convenient to construct more specialized apparatus (e.g., integrated circuits) to perform the required method steps. Thus, the invention may be implemented in one or more computer programs executing on one or more programmable computer systems each comprising at least one processor, at least one data storage system (including volatile and non-volatile memory and/or storage elements), at least one input device or port, and at least one output device or port. Program code is applied to input data to perform the functions described herein and generate output information. The output information is applied to one or more output devices, in known fashion.

Each such program may be implemented in any desired computer language (including machine, assembly, or high level procedural, logical, or object oriented programming languages) to communicate with a computer system. In any case, the language may be a compiled or interpreted language.

Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein. (Software per se and intangible signals are excluded to the extent that they are unpatentable subject matter.)

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method of distributing content, comprising:
associating at least one authorized display mode with the content;
generating a transport stream that includes the content and the at least one authorized display mode;
encoding the transport stream;
transmitting, by a first device, the transport stream having been encoded;
receiving, by a second device, at least one device display mode;
decoding the transport stream to generate the content and the at least one authorized display mode;
comparing the at least one device display mode and the at least one authorized display mode; and
outputting the content according to a result of the comparing.

2. The method of claim 1, wherein the content comprises video on demand content.

3. The method of claim 1, wherein associating the at least one authorized display mode comprises:
associating at least one authorized display mode with the content using extensible markup language (XML) metadata.

4. The method of claim 1, wherein the transport stream corresponds to an MPEG-2 (moving pictures experts group) format that includes the content in a video portion and that includes the at least one authorized display mode in an ECM (entitlement control message) portion.

5. The method of claim 1, wherein the at least one device display mode corresponds to a high definition multimedia interface and a high-bandwidth digital content protection standard.

6. The method of claim 1, wherein the at least one device display mode corresponds to a high definition multimedia interface and a digital video interface standard.

7. The method of claim 1, wherein the content is output when the at least one authorized display mode corresponds to the at least one device display mode.

8. A device for displaying content, comprising:
a decoder that receives an encoded transport stream, wherein the encoded transport stream includes the content and at least one authorized display mode, and that decodes the transport stream to generate the content and the at least one authorized display mode;
a conditional access system, coupled to the decoder, that receives at least one device display mode, that compares the at least one device display mode and the at least one authorized display mode, and that outputs a control signal; and
an output, coupled to the decoder and to the conditional access system, that outputs the content according to the control signal.

9. The device of claim 8, further comprising:
a demodulator that receives a modulated, multiplexed, encoded transport stream and that generates a multiplexed, encoded transport stream; and
a demultiplexer that receives the multiplexed, encoded transport stream and that generates the encoded transport stream.

10. The device of claim 8, wherein the at least one device display mode corresponds to a display device coupled to the conditional access system.

11. The device of claim 8, wherein the at least one device display mode corresponds to a display device coupled to the conditional access system via a high definition multimedia interface and a high-bandwidth digital content protection standard.

12. The device of claim 8, wherein the at least one device display mode corresponds to a display device coupled to the conditional access system via a high definition multimedia interface and a digital video interface standard.

13. The device of claim 8, wherein the content is output when the at least one authorized display mode corresponds to the at least one device display mode.

14. A method of displaying content, comprising:
receiving an encoded transport stream, wherein the encoded transport stream includes the content and at least one authorized display mode;
receiving at least one device display mode;
decoding the transport stream to generate the content and the at least one authorized display mode;
comparing the at least one device display mode and the at least one authorized display mode; and
outputting the content according to a result of the comparing.

15. The method of claim 14, wherein the at least one device display mode corresponds to a high definition multimedia interface and a high-bandwidth digital content protection standard.

16. The method of claim 14, wherein the at least one device display mode corresponds to a high definition multimedia interface and a digital video interface standard.

17. The method of claim 14, wherein the content is output when the at least one authorized display mode corresponds to the at least one device display mode.

18. A system for distributing content, comprising:
a distribution device that associates at least one authorized display mode with the content, that generates a transport stream that includes the content and the at least one authorized display mode, that encodes the transport stream, and that transmits the transport stream having been encoded; and
a receiver device that receives at least one device display mode, that decodes the transport stream to generate the content and the at least one authorized display mode, that compares the at least one device display mode and the at least one authorized display mode, and that outputs the content according to a result of the comparing.

19. The system of claim 18, further comprising:
a display device, having associated therewith the at least one device display mode, that communicates the at least one device display mode to the receiver device.

20. The system of claim 18, wherein the receiver device outputs the content when the at least one authorized display mode corresponds to the at least one device display mode.
